(19) United States
(12) Patent Application Publication
(10) Pub. No.: US 2002/0003001 A1
(43) Pub. Date: Jan. 10, 2002

(54) Surface tension valves for microfluidic applications

(76) Inventors: Bernhard H. Weigl, Seattle, WA (US); Gerald L. Klein, Edmonds, WA (US)

Correspondence Address: JERROLD J. LITZINGER, SENTRON MEDICAL, INC., 4445 LAKE FOREST DR., SUITE 600, CINCINNATI, OH, 45242, US

(21) Appl. No.: 09/864,023

(22) Filed: May 23, 2001

Related U.S. Application Data
(60) Provisional application No. 60/206,878, filed on May 24, 2000.

(51) Int. Cl. F15B 21/00

(52) U.S. Cl. 137/806

(57) ABSTRACT

A passive valve for use within microfluidic structures. Surface tension forces developed within microscale channels are used to control flow within the channels. Flow can be halted within a channel until fluid force reaches a predetermined pressure to allow the channel to open.

### CROSS-REFERENCE TO RELATED APPLICATIONS

This patent application claims benefit from U.S. Provisional Patent Application Ser. No. 60/206,878, filed May 24, 2000, which application is incorporated herein in its entirety by reference.

### BACKGROUND OF THE INVENTION

1. Field of the Invention

This invention relates generally to microscale devices for performing analytical testing and, in particular, to surface tension valves for controlling flow within microfluidic channels.

2. Description of the Prior Art

Microfluidic devices have recently become popular for performing analytic testing. Using tools developed by the semiconductor industry to miniaturize electronics, it has become possible to fabricate intricate fluid systems which can be inexpensively mass produced. These techniques may be used to enable the development of miniaturized fluidic circuits as building blocks for an advancement in the fields of medical diagnostics and chemical analysis.

One aspect of microfluidics technology is based on the very special behavior of fluids when flowing in channels approximately the size of a human hair. This phenomenon, known as laminar flow, exhibits very different properties within a microscale channel than fluids flowing within the macro world of everyday experience. Due to the extremely small inertial forces in microscale structures, practically all flow in microfluidic channels is laminar. This allows the movement of different layers of fluid and particles next to each other in a channel without any mixing, except for diffusion.

Microfluidic technology can be used to deliver a variety of in vitro diagnostic applications at the point of care, including blood cell counting and characterization, and calibration-free assays directly in whole blood. There are also other applications for this technology, including food safety, industrial process control, and environmental monitoring. The reduction in size and ease of use of these systems allows the devices to be deployed closer to the patient, where quick results facilitate better patient care management, thus lowering healthcare costs and minimizing inconvenience. In addition, this technology has potential applications in drug discovery, synthetic chemistry, and genetic research.

Control of fluid movement within microfluidic channels is usually accomplished by the use of mechanical valves. An example of such a valve is taught in U.S. patent application Ser. No. 09/677,250, entitled “Valve for Use In Microfluidic Structures”, filed Oct. 2, 2000, and is assigned to the assignee of the present invention. This application describes a valve manufactured from a flexible material which allows one-way flow through microfluidic channels for directing fluids through a microfabricated analysis cartridge. This type of valve, however, is often difficult to fabricate due to its extremely small dimensions.

It has also been proposed to use passive or nonmechanical means to control fluid movement in microfluidic channels. U.S. Pat. No. 6,193,471 is directed to a process and system for introducing menisci, arresting the movement of menisci at defined locations within the system, and for removing menisci from capillary volumes of a liquid sample, as well as delivering precise small volumes of liquid samples to a point of use.

U.S. Pat. No. 6,130,098, which issued on Oct. 10, 2000, is directed to microscale devices using flow-directing means including a surface tension gradient mechanism in which discrete droplets are differentially heated and propelled through etched channels. Electronic components are fabricated on the same substrate material, allowing sensors and controlling circuitry to be incorporated in the same device.

### SUMMARY OF THE INVENTION

It is therefore an object of the present invention to provide a passive valve within a microfluidic system which uses surface tension forces to control flow within the microfluidic channels.

It is also an object of the present invention to provide a valve within a microfluidic channel such that the channel will open at a predetermined fluid pressure.

These and other objects and advantages of the present invention will be readily apparent in the description that follows.

### BRIEF DESCRIPTION OF THE DRAWINGS

FIG. 1 is an illustration of a microfluidic channel having sharp edges;

FIG. 2 is an illustration of the channel of FIG. 1 containing a fluid having a meniscus extending beyond its edge;

FIG. 3 is an illustration of a microfluidic channel having a plurality of branched channels;

FIG. 4 is an illustration of a microfluidic channel having a central barrier within the channel;

FIG. 5 is an illustration of a microfluidic channel having stepped branches;

FIG. 6 is an illustration of an embodiment of a valve according to the present invention at intersecting microfluidic channels depicting a fluid in one channel;

FIG. 7 shows the channels of FIG. 6 depicting fluids within both channels; and

FIG. 8 is an illustration of a microfluidic channel having a soluble material deposited on its walls.

### DESCRIPTION OF THE PREFERRED EMBODIMENTS

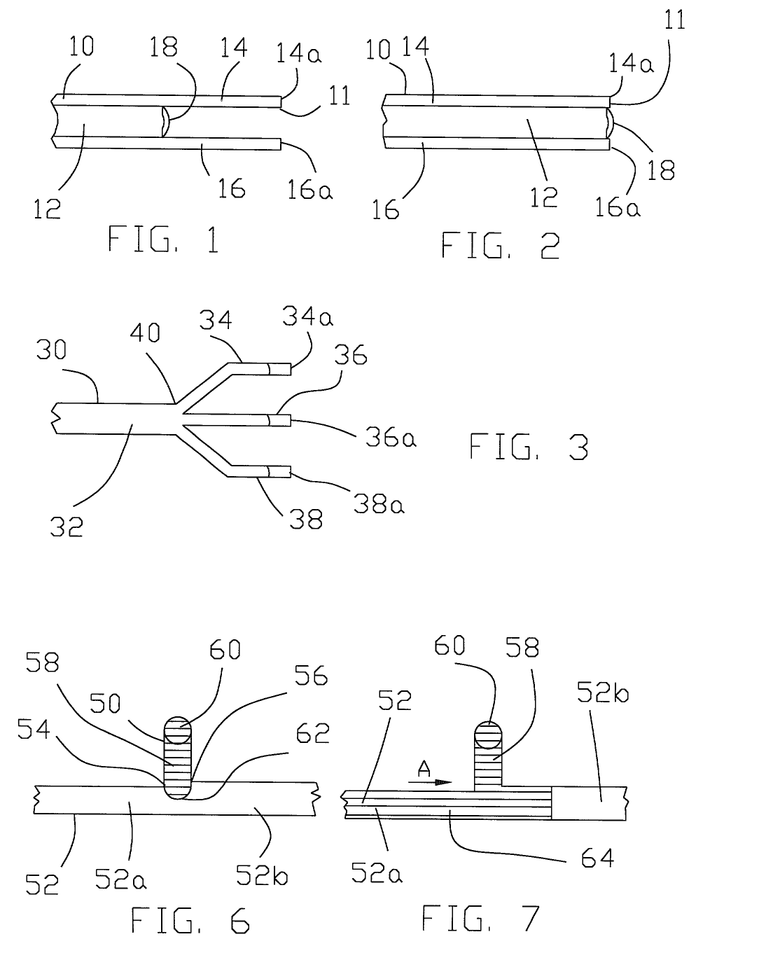

Referring now to FIG. 1, there is shown a microfluidic channel 10 having an end 11 and containing a fluid 12 within its walls 14, 16. A concave meniscus 18 is formed at the leading edge of flowing fluid 12 within channel 10. Edges 14a, 16a of channel walls 14, 16 are formed at approximately 90° which constitute “sharp edges”, thus causing surface tension forces within flowing fluid 12. As can be clearly seen in FIG. 2, fluid 12 moves within channel 10 due to a positive pressure upstream or a positive displacement. Its flow velocity is determined by several factors, including the magnitude of the pressure and the fluidic resistance of channel 10. When fluid 12 reaches end 11 of channel 10 which contains sharp edges 14a and 16a, the fluidic resistance increases, and if the driving pressure is less than the force needed to overcome the surface tension resistance at edges 14a, 16a, the flow of fluid 12 will stop, and meniscus 18 will distend into the open space beyond edges 14a, 16a.

The shape of the meniscus depends on several factors, such as properties of the material that composes the channel along with properties of the flowing fluid. For example, meniscus 18 may adopt a convex shape if the properties of the fluid and channel walls are conducive to the formation of that shape. Another factor which is related to this phenomenon is the angle of contact. If a liquid is in contact with a solid and with air along a line, the angle θ between the solid-liquid interface and the liquid-air interface is called the angle of contact. If θ=0, the liquid is said to wet the channel thoroughly. If θ is less than 90°, the liquid moves within the channel and forms a concave meniscus; and if more than 90°, the liquid does not wet the solid and is depressed within the channel, forming a convex meniscus.

This phenomenon can also be used as a stream splitter when desirable. Referring now to FIG. 3, a main channel 30 contains a fluid 32 which flows toward a series of channel branches 34, 36, 38 at the distal end 40 of channel 30. As fluid 32 flows toward end 40, it will partition and flow at different velocities in each of channels 34, 36, 38 due to variation in the resistance within each channel. When fluid within fastest flowing channel 34 reaches a sharp edge boundary 34a, flow will stop. Fluid in the second fastest flowing channel 36 will then reach a sharp edge boundary 36 and stop, while fluid within the slowest flowing channel 38 will finally reach a sharp edge boundary 38a. The sizes and characteristics of channels 34, 36, 38 can be varied to control the speed of the flow in each channel.

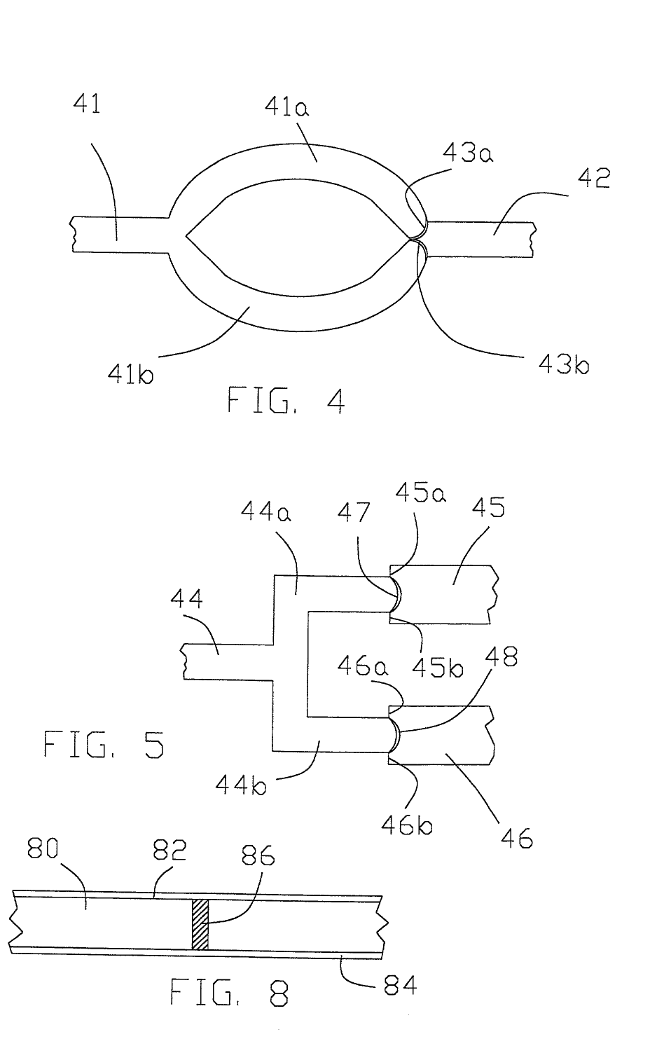

FIG. 4 shows another embodiment which uses branched fluidic channels to control fluid flow. A channel 41 divides into two arcuate paths 41a, 41b which converge at a channel 42 at a distance from channel 41. A fluid traveling within channel 41 will divide and flow into channels 41a, 41b at different velocities until surface tension forces stop the flow and form menisci 43a, 43b at the junction of channels 41a, 41b and 42. These junctions act as passive valves to control flow into channel 42. The type of channel, materials, sizes, and fluid pressure all contribute to the forces necessary to overcome the surface tension which forms menisci 43a, 43b.

FIG. 5 shows a further embodiment using branched fluidic channels for fluid control. A main channel 44 divides into two separate branch channels 44a, 44b. Channel 44a is connected to a wider channel 45, while channel 44b is also connected to a wider channel 46. Edges 45a, 45b of the junction of channels 44a and 45 constitute “sharp edges” as discussed earlier while edges 46a, 46b of the junction of channels 44b and 46 also contain sharp edges.

As fluid flows within channel 44 and divides into channels 44a and 44b, the fluid will stop as it reaches edges 45a, 45b and 46a, 46b respectively, and if the driving pressure of the fluid is less than the force needed to overcome the surface tension at these edges, menisci 47, 48 will form at the junction of the respective channels. Each channel can be constructed of the appropriate materials, or treated with hydrophobic or hydrophilic materials, to provide the proper surface tension resistance to the flow through channel 44 to achieve the desired flow timing from channels 44a and 44b.

FIG. 6 shows an embodiment of microfluidic channels containing a passive valve using the principles of the present invention. Referring now to FIG. 6, a first microfluidic channel 50 is intersected by a second microfluidic channel 52. The intersection of channels 50, 52 is formed by a pair of sharp edges 54, 56 which are offset such that channel 52 is separated into two channels 52a and 52b having different widths.

A fluid stream 58 enters channel 50 via a port 60 and flows until it contacts sharp edges 54, 56 at the intersection of channels 50 and 52, where the flow stops due to surface tension. Stopped stream 58 forms a meniscus 62 which distends into channel 52. To restart fluid flow within channel 50, a fluid stream 64 is initiated in channel section 52a in the direction indicated by arrow A, as can be seen in FIG. 7. As fluid stream 64 contacts meniscus 62, the surface tension holding fluid stream 58 within channel 50 is overcome, thus reinitiating fluid flow from port 60 through channel 50 and into channel section 52b. Although meniscus 62 is convex, this valve will operate if the meniscus is concave, as fluid stream 64 would contact the meniscus in channel 50 and reinitiate the flow.

Surface tension valves may also be created in microfluidic channels by the use of hydrophobic or hydrophilic materials. For example, if a hydrophobic material is deposited in one or several spots within a channel, it would act like a valve in a microfluidic circuit for aqueous fluids. Referring now to FIG. 8, there is shown a microfluidic channel 80 having a pair of parallel walls 82, 84. A track 86 of material is deposited across the width of channel 80. This material may be hydrophobic, such that an aqueous fluid flowing within channel 80 would stop when it reached material 86 if the fluid pressure within channel 80 was below the pressure level needed to overcome the surface tension at that point. Once the pressure exceeds the surface tension, the fluid will flow past material 86, and once channel 80 is witted, the fluid would continue to flow. Material 86 can be added at several positions within channel 80.

It is also possible to deposit a soluble material in the microfluidic channel such that it will act as a valve until the flowing fluid is able to dissolve the material, thus permanently opening the passageway. This material can also be hydrophobic or hydrophilic and can present a certain definable initial resistance due to surface tension.

While this invention has been shown and described in terms of a preferred embodiment, it will be understood that this invention is not limited to any particular embodiment and that changes and modifications may be made without departing from the true spirit and scope of the invention as defined in the appended claims.

What is claimed is:

1. A microfluidic device, comprising:
a microfluidic channel having an inlet and an outlet;
a fluid flowing within said channel;
and a region within said channel between said inlet and said outlet containing material which causes increased surface tension in said fluid at said region,
such that fluid flowing into said inlet requires a fluid driving force greater to cross said region than that required to flow from said inlet to said region.

2. The device of claim 1, wherein said material causing increased surface tension comprises a hydrophobic coating.

3. The device of claim 1, wherein said material comprises a reduced cross-sectional area within said microfluidic channel.

4. The device of claim 1, wherein said region is located adjacent said outlet of said microfluidic channel.

5. The device of claim 1 further comprising a second region within said channel between said first region and said outlet containing a second material which causes a greater increase in surface tension in said fluid at said second region.

6. A passive valve for use in a microfluidic system, comprising:
a microfluidic first channel having a first inlet and a first outlet;
a second channel having a second inlet intersecting said first channel between said first inlet and said first outlet;
a first region located at the intersection of said second inlet and said first channel, having increased surface tension at said first region;
a first fluid flowing within said second channel having a fluid driving force which cannot overcome the surface tension at said first region, and thereby halting flow within said second channel;
and a second fluid flowing within said first channel and contacting said intersection,
such that said second fluid contacts said stopped fluid at said first region, and allows said first fluid to overcome the surface tension at said first region, and causes first and second fluids to flow within said first channel to said outlet.

7. The valve of claim 6, wherein said first region contains a hydrophobic coating.

8. The valve of claim 6, wherein said first region contains a hydrophilic coating.

9. The valve of claim 6, wherein said first channel is constructed from a hydrophobic material.

10. The valve of claim 6, wherein said second channel is constructed from a hydrophobic material.
